(19) United States
(12) Patent Application Publication
(10) Pub. No.: US 2014/0150347 A1
(43) Pub. Date: Jun. 5, 2014

(54) Confined Space Control Cover

(71) Applicant: Thomas Jefferson Porter, IV, League City, TX (US)

(72) Inventor: Thomas Jefferson Porter, IV, League City, TX (US)

(21) Appl. No.: 14/176,530

(22) Filed: Feb. 10, 2014

Related U.S. Application Data
(63) Continuation-in-part of application No. 13/220,644, filed on Aug. 29, 2011, now Pat. No. 8,684,061.
(60) Provisional application No. 61/511,523, filed on Jul. 25, 2011.

(51) Int. Cl. E06B 9/02; G09F 7/00

(52) U.S. Cl. CPC E06B 9/02; G09F 7/00
USPC 49/465

(57) ABSTRACT

A confined space control cover that covers a man-way to a confined space area and prevents a person from breaking the plane of the confined space. The cover includes a base cover, an inwardly projecting lip and a radially extending channel along the lip. The cover is secured by an elastic band or a heavy nylon strapping received in the channel. The strapping has two ends extending from the cover, each end having at least one steel eyelet. A lock is placed through the eyelets on both ends to secure the control cover to the man-way. The control cover may also includes a warning sign disposed on the front of the base cover to prevent persons from entering the confined space area and/or a maintenance tag that is attached to the strapping to indicate maintenance activity performed near or within the confined space area or man-way.

### CROSS-REFERENCE TO RELATED APPLICATIONS

This application is a continuation-in-part of U.S. Ser. No. 13/220,644, filed Aug. 29, 2011, which claims priority to U.S. Provisional Application 61/511,523 filed on Jul. 25, 2011, the entire disclosures of which are incorporated by reference.

### BACKGROUND OF THE INVENTION

There is currently a plurality of confined space control devices available that address confined space areas typically found at chemical plants, refineries, etc. The primary function of the confined space control devices is to alert nearby personnel of confined space areas, e.g., man-ways. The warnings provided by these confined space control devices are often insufficient at preventing fatalities and injuries at the chemical, refining, and other heavy industries in which they are typically employed.

Typical confined space control devices are simply barricade tape, chem tape, wire, and signs. They do not prevent a person from breaking the plane of the confined space and they may be easily overlooked or disregarded by the personnel they are intended to protect. There is a need in the industry for a confined space control cover which covers the entire man-way, such that a person is not able to disregard the presence of the control device and break the plane of the confined space.

There is also a problem with confined space control devices being manipulated and removed by unauthorized personnel. These individuals are sometimes entering the confined space without the proper authorization and are becoming injured or killed. This deficiency can be cured with a lockable confined space cover as described in U.S. application Ser. No. 13/220,644 filed Aug. 29, 2011. To access the manyway, individuals would be required to get authorization from the appropriate responsible party or key holder prior to entering the space.

There is also a need for a confined space control cover, not necessarily lockable, that is securely placed over any confined space man-way that is on a tower, a vessel, a tank or other confined space control location or area and which prevents an individual from breaking the plane of the confined space. In certain cases it may be desirable for the confined space control cover to be lockable.

### SUMMARY OF THE INVENTION

It is an object of the present invention to provide a confined space control cover which is securely placed over any confined space man-way that is on a tower, a vessel, a tank or other confined space control location or area.

It is an object of the present invention to provide a confined space control cover which restricts an individual being able to break the plane of a confined space.

It is an object of the present invention to provide a confined space control cover which is easily and quickly installed.

These and further features and advantages of the present invention will become apparent from the following detailed description, wherein reference is made to the figures in the accompanying drawings.

### BRIEF DESCRIPTION OF THE DRAWINGS

The present invention will be described by way of exemplary embodiments, but not limitations, illustrated in the accompanying drawing in which like references denote similar elements, and in which:

FIG. 1A is an environmental, elevational view of one embodiment of the present invention.

FIG. 1B is a cross-sectional view taken along line 1B-1B in FIG. 1A.

FIG. 2A is an environmental, elevational view of another embodiment of the present invention.

FIG. 2B is a cross-sectional view taken along line 2B-2B in FIG. 2A.

FIG. 3A is an environmental front perspective view of a lockable confined space control cover, in accordance with one embodiment of the present invention.

FIG. 3B is an environmental side perspective view of a lockable confined space control cover, in accordance with one embodiment of the present invention.

### DETAILED DESCRIPTION OF PREFERRED EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not necessarily refer to the same embodiment, however, it may. The terms “comprising”, “having” and “including” are synonymous, unless the context dictates otherwise.

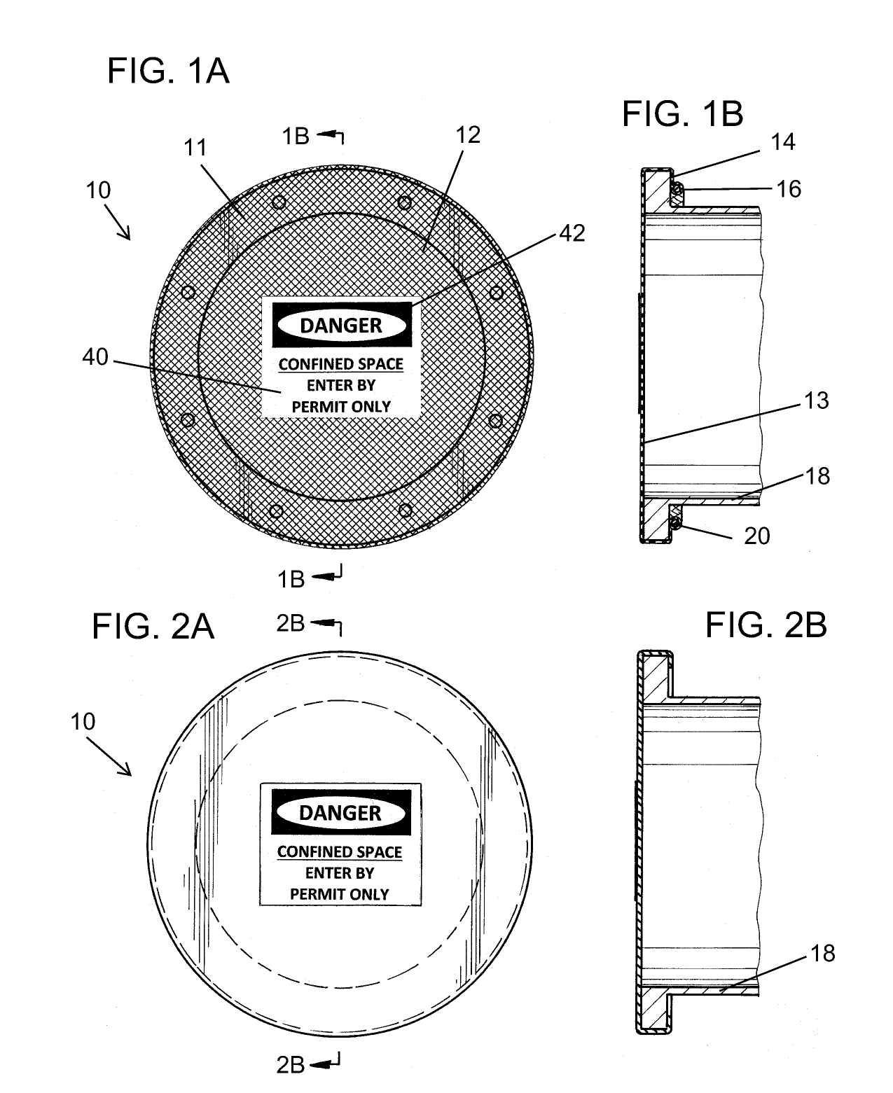

FIG. 1A illustrates a confined space control cover 10 in accordance with one embodiment of the present invention. The confined space control cover 10 includes an exterior surface 11, a front face 12, an interior surface 13, a radially inwardly projecting lip 14 and a peripherally extending channel 16 running along the lip 14.

The channel 16 holds elastic band 20 which is utilized to secure the confined space control cover 10 over the man-way 18. The man-way 18 leads directly to the confined space area. The radially inwardly projecting lip 14 is stretched radially outwardly and placed over the flange of man-way 18, the elastic band 20 pulls the lip 14 against the man-way and pulls front face 12 of cover 10 taut rendering front face 12 substantially planar. This unique design allows the confined space control cover 10 to be securely placed over man-ways of varying size. This eliminates the need for specially sized covers for each man-way. The elastic band 20 can be made of any suitable elastic material.

Cover 10 may include a warning sign 40, typically disposed on the front face 12 of the cover 10, although the warning sign 40 can be disposed anywhere on the base cover 10. The warning sign 40 is typically an occupational safety and health administration or OSHA or other safety regulatory agency sign 42 although the warning sign 40 can be any suitable safety warning sign. More specifically, the warning sign 40 says “DANGER CONFINED SPACE AREA” or other suitably related confined space warning sign wording.

The confined space control cover 10 is securely placed over any confined space man-way that is on a tower, a vessel, a tank or other confined space control location and restricts persons being able to break the plane of the confined space. Cover 10 warns persons in the surrounding area that a confined space area (not shown) is secured and prevents them from entering it without first removing the cover. The cover 10 is made of chemical resistant fabric that will be manufactured in either a solid waterproof fabric (FIG. 1B) or a ventilated fabric/mesh, although the cover 10 can be made of other suitable types of fabric and material as well.

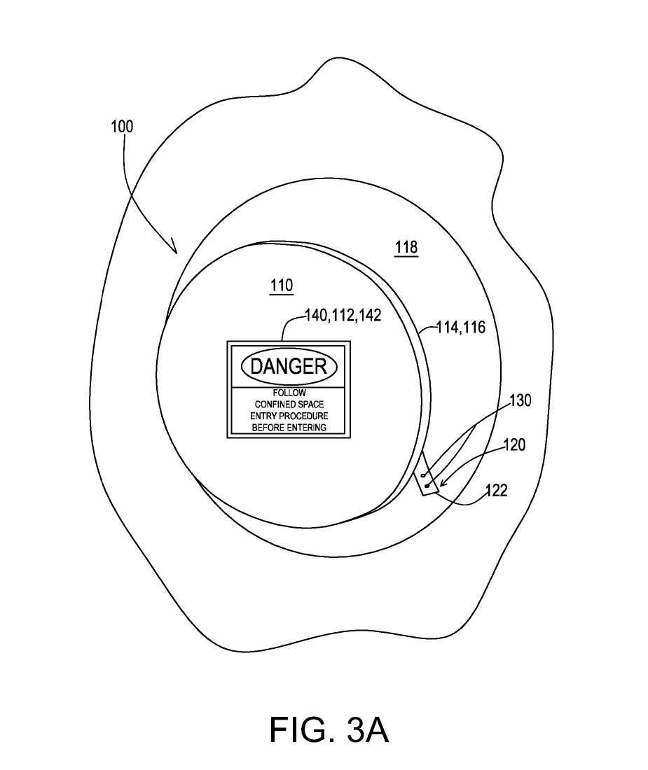

FIGS. 2A and 2B are similar to FIGS. 1A and 1B with the exception that the cover 10 of FIGS. 2A and 2B is made from a solid waterproof fabric rather than ventilated mesh.

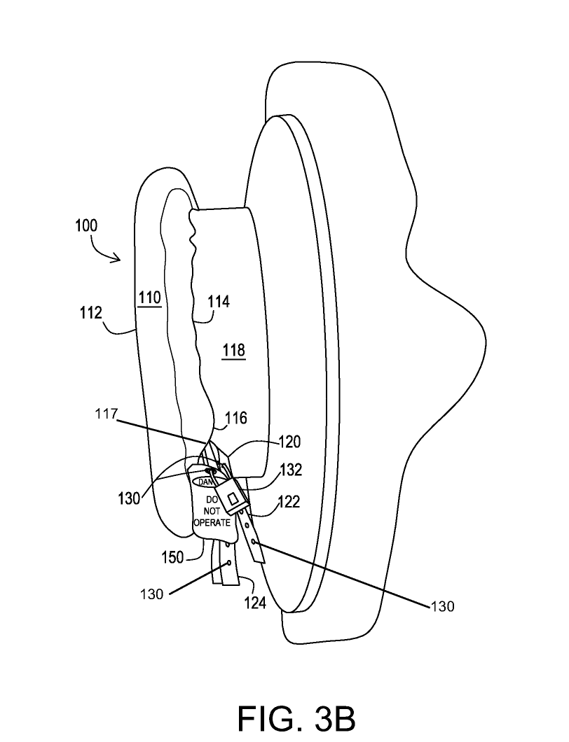

FIG. 3A illustrates a front perspective view of a confined space control cover 100, in accordance with another embodiment of the present invention. The confined space control cover 100 includes a base cover 110, a strapping 120, a plurality of eyelets 130 and a warning sign 140.

The base cover 110 with a front face 112, a radially inwardly projecting lip 114 and a peripherally extending channel 116 covers a man-way 118 to warn and inform persons in the surrounding area that a confined space area (not shown) is secured and locked out. The man-way 118 leads directly to the confined space area. The base cover 110 is preferably made of chemical resistant fabric that can be manufactured in either a solid waterproof fabric or a ventilated fabric/mesh, although the base cover 110 can be made of other suitable types of fabric and material as well. The strapping 120 is made of heavy nylon material that is utilized to secure the confined space control cover 100 over the man-way 118. The strapping 120 is placed through the peripherally extending channel 116. Channel 116 has channel opening 117, preferably on the interior of the base cover. Both ends 122,124 of strapping 120 extend from channel opening 117 such that ends 122, 124 are exposed outside the base cover 110. The result of this design is that when the ends 122, 124 of strapping 120 are pulled, the outer peripheral portion of the base cover 110 is pulled inwards resulting in an outer peripheral diameter that is smaller than the inner portion of the base cover 110. Thus, the confined space control cover 100 can be placed over man-ways of varying size and be secured around the man-way 118. This eliminates the need for specially sized covers for each man-way. The strapping 120 can also be made of other suitable material as well. The eyelets 130 are disposed on both ends 122,124 (FIG. 3B) of the strapping 120 to accommodate a lock 132 (FIG. 3B) that is utilized to secure both ends 122,124 of the strapping 120 around and over the man-way 118. The eyelets 130 are made of steel although the eyelets 130 can be made of any other suitable material as well. The warning sign 140 is typically disposed on the front 112 of the base cover 110, although the warning sign 140 can be disposed anywhere on the base cover 110. The warning sign 140 is typically an occupational safety and health administration or OSHA or other safety regulatory agency sign 142 although the warning sign 140 can be any suitable safety warning sign. More specifically, the warning sign 140 says “DANGER CONFINED SPACE AREA” or other suitably related confined space warning sign wording.

FIG. 3B illustrates a side perspective view of a confined space control cover 100, in accordance with one embodiment of the present invention.

The confined space control cover 100 further includes a maintenance tag 150. The maintenance tag 150 is attached to the strapping 120 to provide an additional warning to one or more persons near or within the confined space area or man-way 118.

The confined space control cover 100 is placed and securely locked over any confined space man-way that is on a tower, a vessel, a tank or other confined space control location or area that can be locked and secured until any testing (including atmospheric testing) is done that eliminates any possibility of one or more persons being able to break the plane of the confined space.

In addition to this lockable confined space control cover working to keep persons from entering a confined space without authorization, it also provides an excellent barrier from water, dust and other elements. The lockable confined space control cover will also be manufactured with an optional ventilated fabric/mesh facing, which will provide the user with the same level of protection while still meeting their need for proper ventilation for the confined space.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

What is claimed is:

1. A cover for restricting access to a man-way to a confined space area, said cover comprising:
a one-piece generally circular cover, said cover having a front face, an exterior surface, an interior surface, and an annular, radially inwardly projecting lip;
a radially extending channel proximal the innermost periphery of said lip;
an elastic band received in said channel;
said lip being movable from a first, relaxed position having a first diameter to a second, expanded position having a second diameter;
said front face being substantially planar when said lip is in said second, expanded position.

2. The cover according to claim 1, wherein said cover is made of waterproof chemical resistant fabric or chemical resistant breathable fabric.

3. The cover according to claim 1, further comprising:
a warning sign disposed on said exterior surface of said cover.

4. The cover according to claim 3, wherein said warning sign is an OSHA sign.

5. The cover according to claim 3, wherein said warning sign says danger confined space area.

6. A cover for restricting access to a man-way to a confined space area, said cover comprising:
a layer of flexible material having a first front side and a second back side, said layer of material being substantially circular when disposed on a planar surface to form a first peripheral edge having a first diameter, said layer of material including an annular, radially inwardly projecting lip portion, said lip portion having a second peripheral edge having a second diameter, said second diameter being less than said first diameter; and
a peripherally extending channel in said lip portion, said channel being adjacent said second peripheral edge of said lip portion;
an elastic band received in said channel, said elastic band having a diameter substantially equal to said second diameter of said lip portion when said flexible material is laying on said planar surface, said lip portion being elastically expandable to said first diameter of said first peripheral edge and elastically retractable to said second diameter of said lip portion.

7. A cover for restricting access to a man-way to a confined space area, said cover comprising:
a generally circular cover having a front face, an exterior surface, and an interior surface, said cover including an innermost portion having a first diameter and a peripheral outermost portion having a second diameter, said peripheral outermost portion having formed therein a peripherally extending channel, said peripherally extending channel having a channel opening;
a strap received in said channel, said strap having a first end and a second end, said first and second ends extending out of said channel opening, whereby when said first end of said strap and said second end of said strap are pulled out of said channel opening of said channel, the second diameter of said peripheral outermost portion of said cover becomes smaller than the first diameter of the innermost portion of said cover;
at least one eyelet in said first end of said strap and at least one eyelet in said second end of said strap.

8. The cover according to claim 7, wherein said base cover is made of waterproof chemical resistant fabric or chemical resistant breathable fabric.

9. The cover according to claim 7, wherein said strap is made of heavy nylon material.

10. The cover according to claim 7, wherein said eyelets accommodate a lock that is utilized to secure said both ends of said strap around and over said man-way.

11. The cover according to claim 7, further comprising:
a warning sign disposed on said front face of said cover.

12. The cover according to claim 11, wherein said warning sign is an OSHA sign.

13. The cover according to claim 11, wherein said warning sign says danger confined space area.

14. The cover according to claim 7, further comprising:
a maintenance tag that is attached to said strap to indicate maintenance activity performed near or within said confined space area or said man-way.

15. The cover according to claim 7, wherein said channel opening is on said interior surface of said cover.
